(19) United States
(12) Patent Application Publication
(10) Pub. No.: US 2007/0158928 A1
(43) Pub. Date: Jul. 12, 2007

(54) STRUCTURAL IMPROVEMENT FOR A FOLDAWAY BICYCLE

(76) Inventor: King-Chang Wu, Fongyuan City (TW)

Correspondence Address: King-Chang Wu, P.O. Box 697, Taichung County, Fongyuan City, 420, TW

(21) Appl. No.: 11/330,162

(22) Filed: Jan. 12, 2006

(51) Int. Cl. B62K 17/00

(52) U.S. Cl. 280/278

(57) ABSTRACT

A structural improvement for a foldaway bicycle includes a head tube having a handlebar on the top and a front wheel at the bottom, a two-piece slant cross bar having a front end pivoted to a positioning device on the head tube, and a rear end respectively connected to a rear wheel and a pair of extensions each of which has a standing roller, a slant down tube having a lower end pivoted to a lug on the head tube and a turning point in a middle portion pivoted to a lug of the cross bar, a driving set having a belt wheel carrying a belt and a crank with pedals pivoted to an inverse U-shaped seat on an underside of the cross bar and a seat tube having an upper periphery connected to the upper end of the down tube, an adjustable saddle with a pulling handle on the top and an elastic pad at a lower end stopped against the top of the inverse U-shaped seat.

### BACKGROUND OF THE INVENTION

The present invention relates to bicycles and more particularly to a structural improvement for a foldaway bicycle which is readily to assemble and readily to fold up.

As we know that a foldaway bicycle means to be capable of holding its rear wheel together with its front wheel so as to have the bicycle to be portable. Earlier foldaway bicycle was found difficult to fold due to its complicated structure. Then the manufactures tried to improve this defect to produce a structurally simplified foldaway bicycle 10 (as shown in FIGS. 1 and 2) which comprises a handle bar 11 on a head tube 12 which connects a front wheel 16 thereunder, a slant cross bar 14 respectively connected to the upper portion of the head tube 12, a rear wheel 17, a seat tube 13 and a chain wheel 141, a slant down tube 15 connected to the lower portion of the head tube 12 and the middle portion of the seat tube respectively and a standing roller 18 on the rear end of a rack 19 which is positioned above the rear wheel 17 and connected to the hub of the rear wheel 17. The down tube 15 has a pair of transverse bars 151 confining the cross bar 14 which has a turning point 142 controlled by a quick release device 143. When unfasten the quick release device 143. The turning point is moving upward. So as the cross bar 14 is more and more becoming an inverse V-shaped configuration and the bicycle 10 is eventually foldaway.

This type of foldaway bicycle 10 fails also to its complicated structure that increases the time and labor to assemble and the user has to apply greater strength to operate.

### SUMMARY OF THE PRESENT INVENTION

The present invention has a main object to provide a structural improvement for a foldaway bicycle which is structurally more simplified and readily folded up.

Accordingly, the structural improvement for a foldaway bicycle of the present invention comprises a head tube having a handle bar on the top and a fork at lower end to rotatably engage a front wheel, a two-piece slant cross bar having a front end pivoted to a positioning device which is slidably engaged on a middle portion of the head tube and controlled by a quick release bar and a rear end connected to the hub of a rear wheel, a pair of extensions connected to the rear end of the cross bar for rotatably securing a pair of standing rollers, an upright seat tube at the middle portion of the bicycle having a saddle on the top and a driving set on the bottom under which is an inverse U-shaped seat engaged with a belt wheel, a crank with a pair of pedals at outer ends and a belt wrapped on the belt wheel and the hub of the rear wheel and a down tube having an upper end connected to the upper portion of the seat tube a lower end pivoted to a lug at lower end of the head tube, a middle portion positioned between the two-piece slant cross bar including a turning point pivoted to the cross bar. When unfasten the quick release bar, the positioning device slides upward and the saddle, the rear wheel gradually move forward until the rear wheel closed to the front wheel and the standing roller stood on the ground, the bicycle is therefore folded up. After the quick release bar is fastened, the rider can carry or drag the bicycle along with him. If moves the positioning device down, the bicycle would display again.

The present invention will become more fully understood by reference to the following detailed description thereof when read in conjunction with the attached drawings.

### BRIEF DESCRPTION OF THE DRAWINGS

FIG. 1 is a perspective view to show a foldaway bicycle according to a prior art,

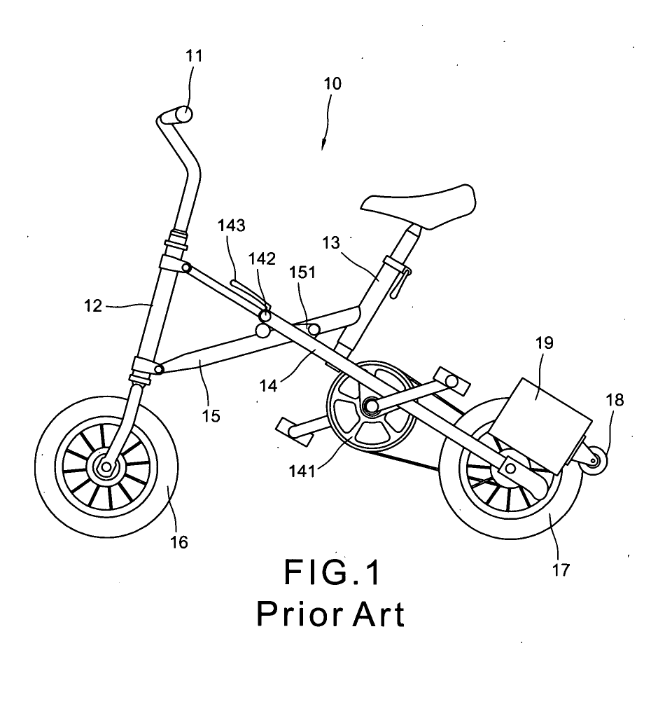

FIG. 2 is a perspective view to show the bicycle of FIG. 1 is folded up,

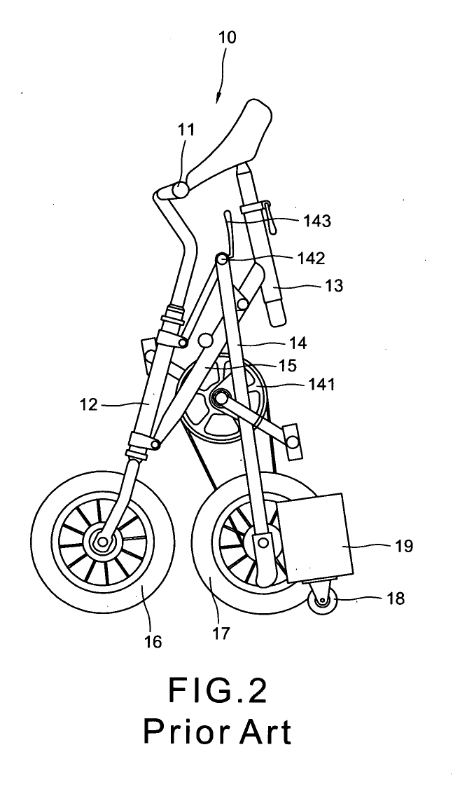

FIG. 3 is a perspective view to show a foldaway bicycle according to the present invention,

FIG. 4 is a side view of FIG. 3,

FIG. 5 is a sectional view to show the details of the positioning device,

FIG. 6 is a perspective view to show that the bicycle is folding,

FIG. 7 is a side view to show that the bicycle is folded up, and

FIG. 8 is a perspective view of FIG. 7.

### DETAILED DESCRIPTION OF THE PREFERRED EMBODIMENT

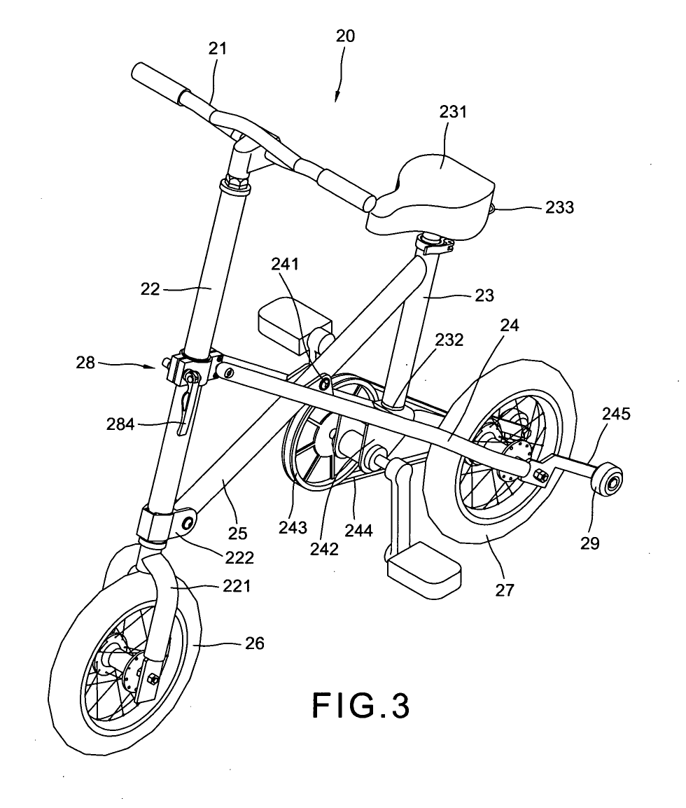

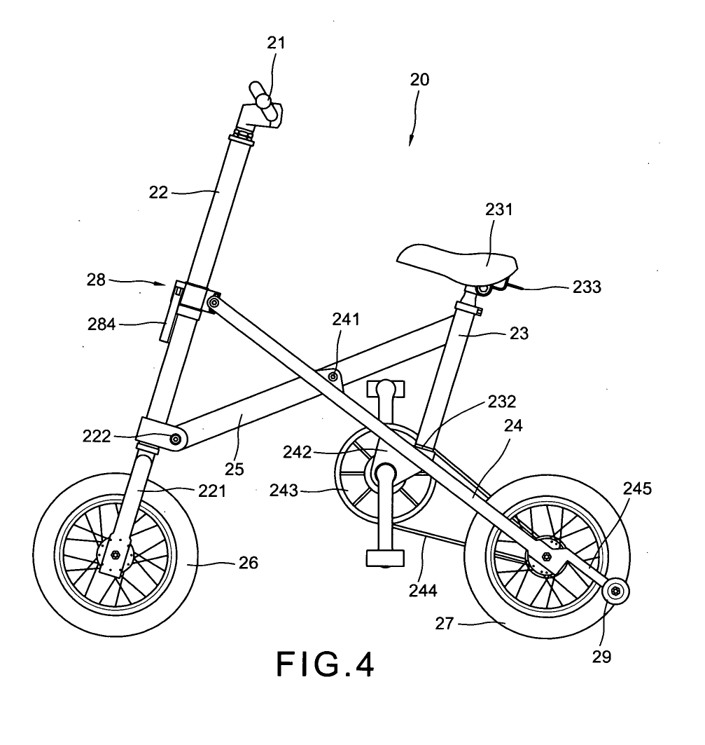

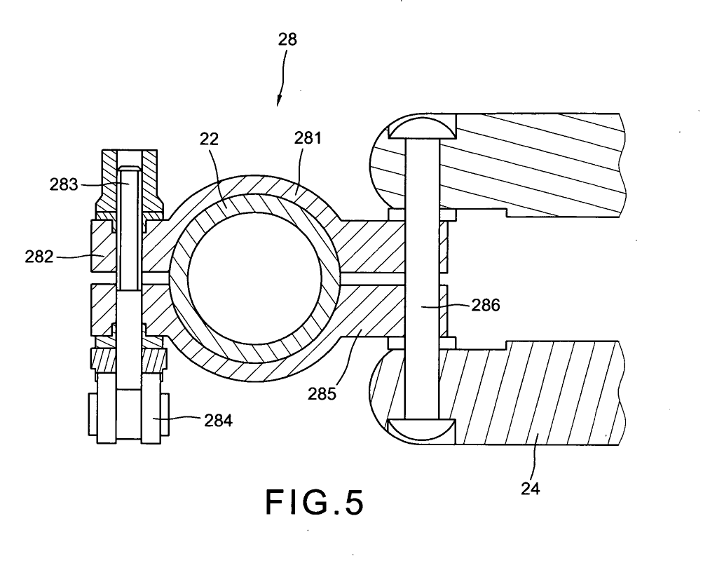

With reference to the drawings and initiated from FIGS. 3 to 5, the structural improvement for a foldaway bicycle of the present invention comprises a foldaway bicycle 20 which is composed of a head tube 22 having a handle bar 21 on the top, a fork 221 at bottom for rotatably engaging with a front wheel 26, a lug 222 above the fork 221 and a positioning device 28 slidably wrapped on a middle periphery which includes a pair of corresponding clamping plates 281 each having an arcuate middle portion engaged with the head tube 22, a straight front portion releasably secured by a bolt 283 and controlled by a quick release bar 284 (as shown in FIGS. 3 and 5) which has a eccentric mechanism and a straight rear end 285 pivotally connected with a two-piece slant cross bar 24 and secured by a double headed retaining pin 286, the slant cross bar 24 has a rear end respectively connected to the hub of a rear wheel 27 and a pair of extensions 245 which are provided to rotatably secure a pair of standing rollers 29, a lug 241 on a top and an inverse U-shaped seat 242 on an underside onto which a driving set is rotatably secured, the driving set includes a belt wheel 243, a belt 244 wrapped on the wheel 243 and the hub of the rear wheel 27 and a crank with a pair of pedals at outer ends rotatably engaged within a tubular axle in the bottom of the inverse U-shaped seat 242, a slant down tube 25 having a lower end through the gap of the cross bar 24 and pivoted to the lug 222 of the head tube 22, a turning point in a middle portion pivoted to the lug 241 of the cross bar 24 and an upper end connected to an upper periphery of a seat tube 23 which is upright and has a vertically adjustable saddle 231 on the top, an elastic pad 232 on the bottom normally stopped against the top of the inverse U-shaped seat 242 and a pushing handle 233 on the rear side of the saddle 231 wherein the elastic pad 232 is provided for damp-proof purpose and may be made of an elastic plate, a spring means or any other elastic material.

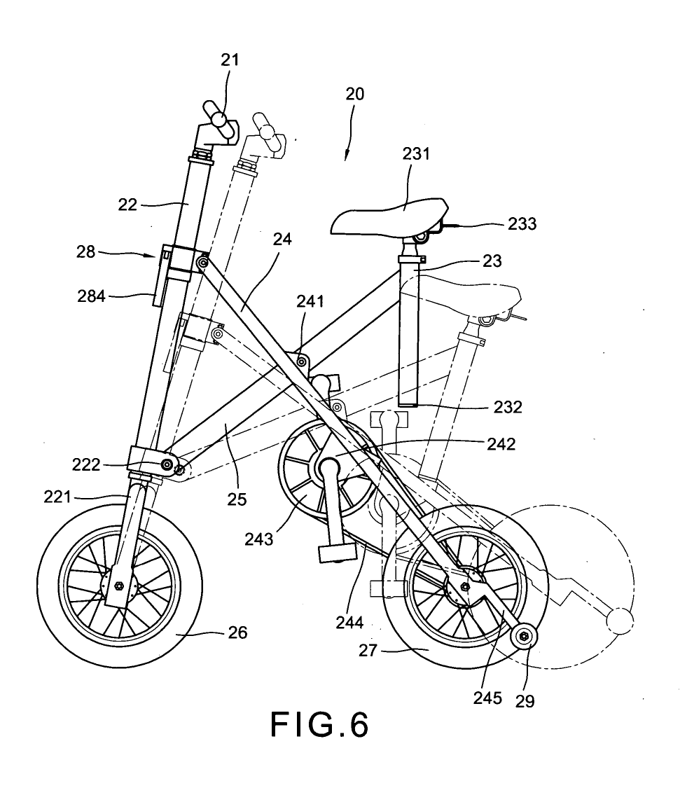

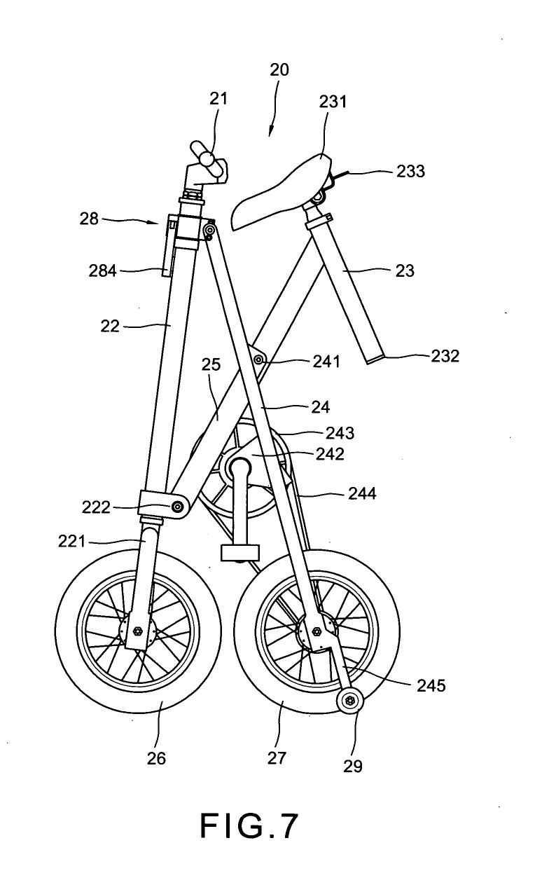

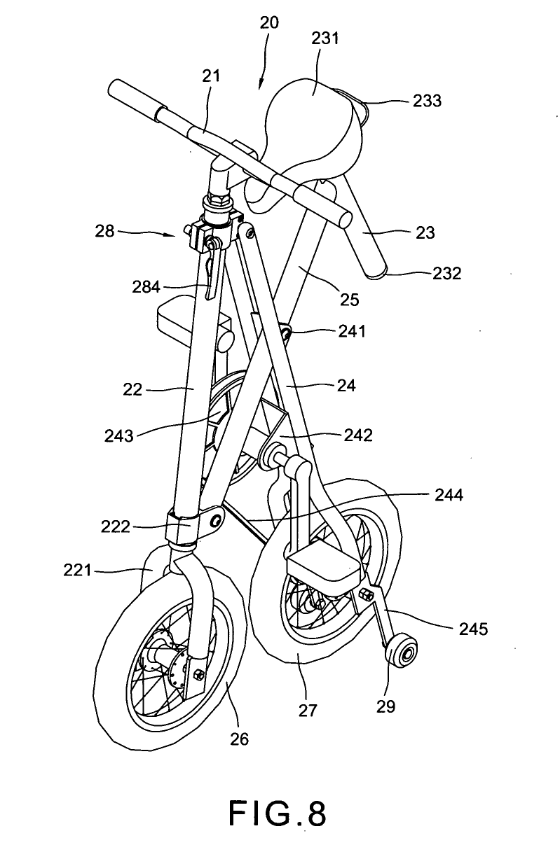

Referring to FIGS. 6, 7 and 8 of the drawings, when folding, unfasten the quick release bar 284 to enable the positioning device 28 together with the front end of the cross bar 24 automatically sliding upward along the head tube 22 due to the weight of the elements on the cross bar 24 which together with the down tube 25 will be gradually forming a narrow X-shaped configuration until that the rear wheel 27 is closed to the front wheel 26, the positioning device 28 is already slide onto the uppermost position of the head tube 22, then fasten the quick release bar 284, the bicycle 20 is therefore folded up becoming portable and the pair of standing rollers 29 are standing on the ground. This time, the rider can grasp the pulling bar 233 to carry or to drag the bicycle 20 along with him. When displaying, unfasten the quick release bar 284 again and push the positioning device downward to slide to its original position, the saddle 231 and the rear wheel 27 are also displayed to their original positions, too, then fasten the quick release bar 284, so that the bicycle 20 becomes ridable. Note the standing rollers 29 are structurally and functionally different to rollers for a children bicycle which are merely for balancement purpose. Although the rider forgets to fasten the quick release bar 284 on riding, the bicycle 20 will keep stable because of the weight of the rider himself.

The above discussions prove that the foldaway bicycle 20 of the present invention achieves a structural simplification and easy operation on folding or on displaying. It gives great convenience to the rider.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

1. A structural improvement for a foldaway bicycle comprising:
a head tube having a handlebar on top, a fork at a bottom of said head tube to rotatably engage a front wheel thereinbetween, a first lug above said fork and a positioning device slidably disposed on a middle periphery of said head tube;
a two-piece slant cross bar having a front end pivoted to said positioning device, a rear end pivoted to a hub of a rear wheel, a second lug on extending from a top surface of said cross bar and an inverse U-shaped seat on an underside of said cross bar including a tubular axle to rotatably engage with a driving set;
a slant down tube having a lower end pivoted to the first lug of said head tube, a turning point in a middle portion pivoted with the second lug of said cross bar and an upper end connected to an upper periphery of a seat tube which has a vertically adjustable saddle on top, an elastic pad at a bottom of said head tube stopped against a top of said inverse U-shaped seat and a pulling handle on a rear end of said saddle;
whereby, said bicycle is foldable when said positioning device is unfastened and slid upward about an outer periphery of said head tube.

2. The structural improvement according to claim 1, wherein said positioning device comprises a pair of corresponding clamping plates each having an arcuate middle portion slidably engaged with an outer periphery of said head tube, a straight front end secured by a bolt and a quick release bar and a straight rear end pivoted to said cross bar and secured by a double-head retaining pin.

3. The structural improvement according to claim 2, wherein said quick release bar has an eccentric mechanism.

4. The structural improvement according to claim 1, wherein said driving set has a belt wheel, a crank with a pair of pedals on an outer end and a belt wrapped on said belt wheel and the hub of said rear wheel.

5. The structural improvement according to claim 1, wherein said elastic pad is made of spring means and/or elastic materials.

6. The structural improvement according claim 1, further having a pair of extensions connected to the rear end of said cross bar each including a standing roller pivoted at an free end of said extensions.
